(19) United States
(12) Patent Application Publication
(10) Pub. No.: US 2014/0047035 A1
(43) Pub. Date: Feb. 13, 2014

(54) DISTRIBUTING COLLABORATIVE COMPUTER EDITING SYSTEM

(71) Applicant: QUANTA COMPUTER INC., Tao Yuan Shien (TW)

(72) Inventors: Juin-Yi HUANG, Taipei City (TW); Chih-Han CHAN, Tainan City (TW)

(73) Assignee: QUANTA COMPUTER INC., Tao Yuan Shien (TW)

(21) Appl. No.: 13/754,890

(22) Filed: Jan. 30, 2013

(30) Foreign Application Priority Data
Aug. 7, 2012 (TW) 101128450

(51) Int. Cl. H04L 29/06

(52) U.S. Cl. CPC H04L 65/403
USPC 709/205

(57) ABSTRACT

A distributing collaborative computer editing system is provided. The computer editing system includes a storage unit, a searching unit, a splitting unit, a distributing unit and an aggregating unit. The storage unit is used for storing a multimedia provided from a host. The searching unit is used for searching a plurality of collaborators via a social network service associated with the host. The splitting unit is used for splitting the multimedia into a plurality of parts. The distributing unit is used for distributing those parts to the collaborators, such that the collaborators can edit those parts respectively. The aggregating unit is used for aggregating those edited parts.

This application claims the benefit of Taiwan application Serial No. 101128450, filed Aug. 7, 2012, the subject matter of which is incorporated herein by reference.

### BACKGROUND OF THE INVENTION

1. Field of the Invention

The invention relates in general to a computer editing system, and more particularly to a distributing collaborative computer editing system.

2. Description of the Related Art

Along with the advance in digital audio/video capturing technology, various digital video recorders or digital recording pens have been provided and become very popular. People may conveniently and easily record film or voice with these electronic devices.

Meanwhile, along with the rapid advance in multimedia editing technology, various sorts of multimedia editing software are provided and updated. The user may add label texts or marks to the film. Through the user's smart editing, an ordinary film may turn out to be lively and versatile.

### SUMMARY OF THE INVENTION

The invention is directed to a distributing collaborative computer editing system, which completes multimedia editing in a distributing and collaborative manner via the social network service, not only increasing the efficiency in multimedia editing but also adding more funs to the editing and creating more interaction between people.

According to an embodiment of the present invention, a distributing collaborative computer editing system is provided. The computer editing system includes a storage unit, a searching unit, a splitting unit, a distributing unit and an aggregating unit. The storage unit is used for storing a multimedia provided from a host. The searching unit is used for searching a plurality of collaborators via a social network service associated with the host. The splitting unit is used for splitting the multimedia into a plurality of parts. The distributing unit is used for distributing those parts to the collaborators, such that the collaborators can edit those parts respectively. The aggregating unit is used for aggregating those edited parts.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a distributing collaborative computer editing system;

FIG. 2 shows a schematic diagram of another distributing collaborative computer editing system;

FIG. 3 shows a schematic diagram of another distributing collaborative computer editing system;

FIGS. 4 to 5 show a schematic diagram of a multimedia;

FIG. 6 shows a schematic diagram of an instant communication interface; and

FIG. 7 shows a schematic diagram of an edited and aggregated multimedia.

### DETAILED DESCRIPTION OF THE INVENTION

A number of embodiments are disclosed below for elaborating the invention. However, the embodiments of the invention are for detailed descriptions only, not for limiting the scope of protection of the invention. Furthermore, secondary or unimportant elements are omitted in the accompanying diagrams of the embodiments for highlighting the technical features of the invention.

The invention provides a distributing collaborative computer editing system, which completes multimedia editing in a distributing and collaborative manner via the social network service, not only increasing the efficiency in multimedia editing but also adding more funs to the editing and creating more interaction between people.

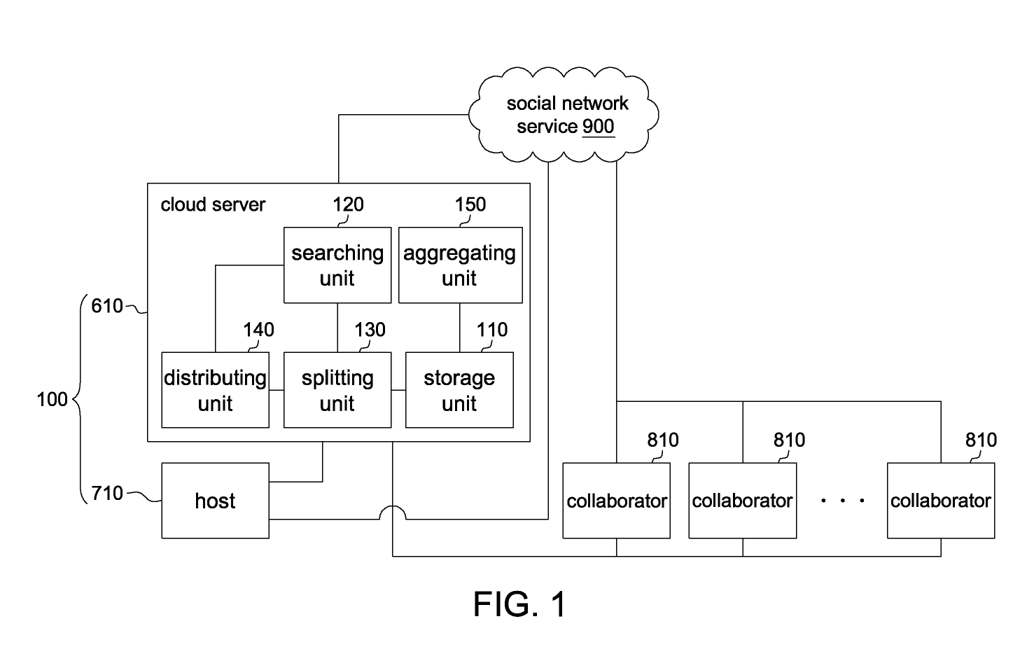

Referring to FIG. 1, a schematic diagram of a distributing collaborative computer editing system 100 is shown. The distributing collaborative computer editing system 100 includes a storage unit 110, a searching unit 120, a splitting unit 130, a distributing unit 140 and an aggregating unit 150. The storage unit 110 is used for storing various sources of data including multimedia. The storage unit 110 is such as a hard disc, a memory or an optical disc. The data comes from the host 710 or the collaborator 810. The host 710 or the collaborator 810, realized by such as a hand-held electronic device, at least includes an image capturing module and a network module for uploading the image or video captured by the image capturing module to a server or a cloud server 610 or other electronic devices. The host 710 is the hand-held electronic device which activates the distributing collaborative computer editing system. The collaborator 810 can be another hand-held electronic device participating in the multimedia editing. The searching unit 120 is used for searching the collaborator 810 and the information thereof via the network. The splitting unit 130 is used for splitting data. The distributing unit 140 is used for distributing the split data, that is, the distributing unit 140 distributes the split data to the collaborator 810. The aggregating unit 150 is used for aggregating or merging the split and edited data. The searching unit 120, the splitting unit 130, the distributing unit 140 and the aggregating unit 150 are such as a processing chip, a firmware circuit, a storage medium storing several programming codes. In addition, the searching unit 120, the splitting unit 130, the distributing unit 140 and the aggregating unit 150 may be executed by a single chip or a plurality of chips.

Please refer to FIG. 1. The storage unit 110, the searching unit 120, the splitting unit 130, the distributing unit 140 and the aggregating unit 150 are disposed in the cloud server 610. The host 710 executes a collaborative multimedia editing procedure through the cloud server 610. The host 710 and the collaborator 810 with an application program (APP) for communicating the cloud server 610 is able to execute the collaborative multimedia editing procedure.

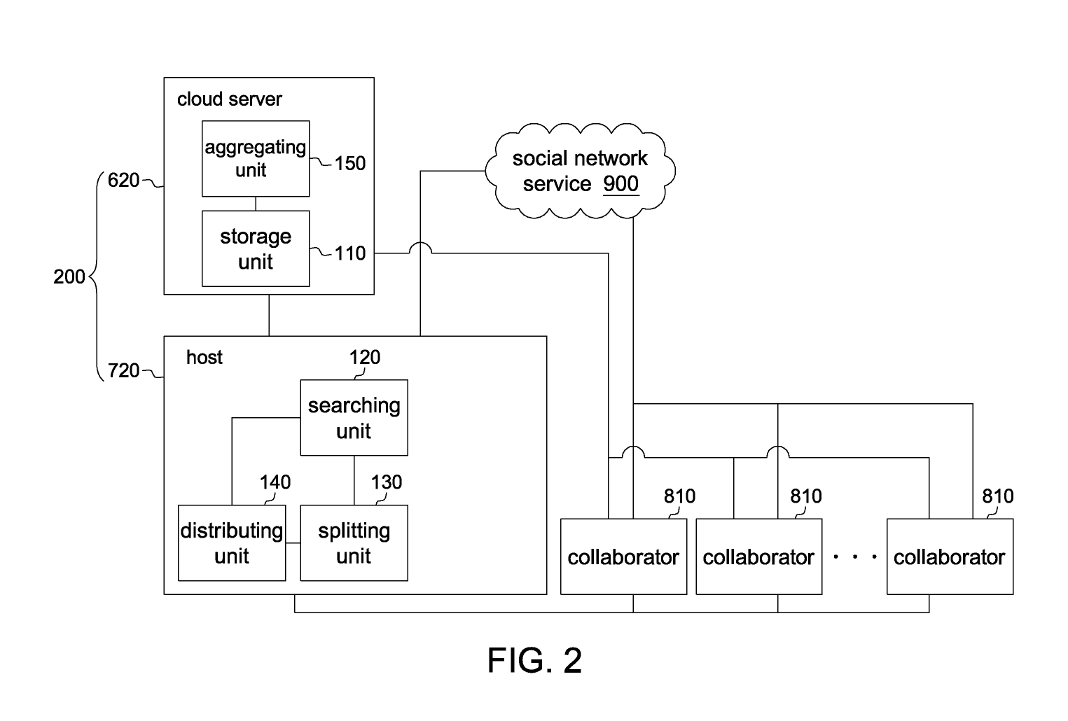

Please referring to FIG. 2, a schematic diagram of another distributing collaborative computer editing system 200 is shown. In an embodiment, the searching unit 120, the splitting unit 130 and the distributing unit 140 are disposed in a hand-held electronic device of the host 720, while the storage unit 110 and the aggregating unit 150 are disposed in the cloud server 620. The searching unit 120, the splitting unit 130 and the distributing unit 140 are disposed in the host 720 to enhance the independence of the host 720. The host 720 may directly set and control the searching procedure of the searching unit 120, the splitting procedure of the splitting unit 130 and the distributing procedure of the distributing unit 140. The storage unit 110 requiring large storage capacity and the aggregating unit 150 requiring powerful computing ability may both be disposed in the remote cloud server 620. Thus, the hand-held electronic device of the host 720 possesses instant control efficiency and the cloud server 620 helps to increase the storage and processing efficiency.

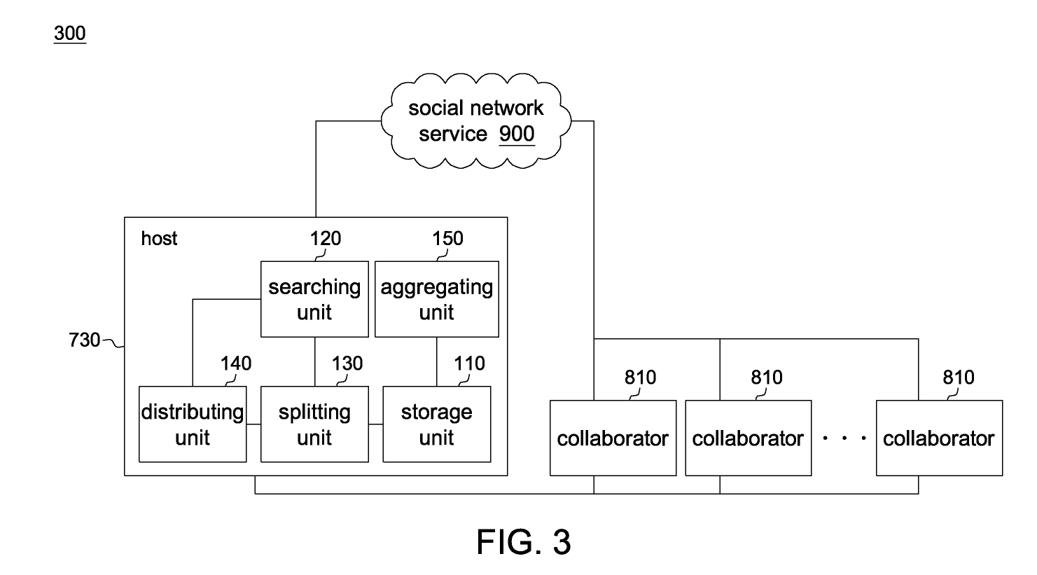

Referring to FIG. 3, a schematic diagram of another distributing collaborative computer editing system 300 is shown. In an embodiment, the storage unit 110, the searching unit 120, the splitting unit 130, the distributing unit 140 and the aggregating unit 150 are disposed in the hand-held electronic device of the host 730. In the embodiment illustrated in FIG. 3, the host 730 independently sets and controls the searching procedure of the searching unit 120, the splitting procedure of the splitting unit 130 and the distributing procedure of the distributing unit 140, and can further store the data through the storage unit 110 or directly aggregate data through the aggregating unit 150. Thus, the time required for data transmission and communication with the remote cloud server 620 can be saved.

It is noted that the disposition of the storage unit 110, the searching unit 120, the splitting unit 130, the distributing unit 140 and the aggregating unit 150 is not limited to the implementation illustrated in FIGS. 1 to 3, and various implementations of disposition are still within the scope of protection of the disclosure.

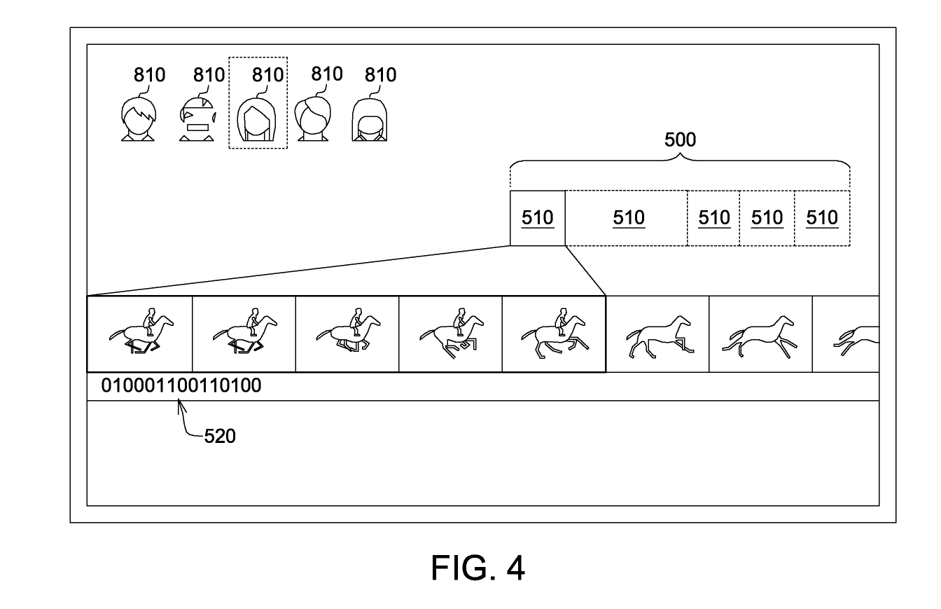

Let FIG. 1 be taken for example. The storage unit 110 is used for storing a multimedia 500 (illustrated in FIG. 4) provided from the host 710. The multimedia 500 is such as a video file or an audio file. The host 710 may record the multimedia 500 by itself or download the multimedia 500 from the network and then stores the downloaded data in the storage unit 110.

The searching unit 120 is used for searching a plurality of collaborators 810 associated with the host 710 via a social network service 900. The social network service 900 is such as facebook, microblogging or Google+. The host 710 records a number of friends (such as the contact list in the facebook or members of the societies or clubs that the user joins) in the social network service 900. The searching unit 120 may regard the friends currently on line with the social network service 900 as the collaborators 810. When the searching unit 120 searches the collaborators 810, and further records the information of each collaborator 810 such as interests and photos, the processing efficiency of the hand-held electronic device of each collaborator 810, the geographic position or the network status. The interests and photos of each collaborator 810 may be obtained from the personal information setting, article content and shares photos of the social network service. The processing efficiency of the hand-held electronic device of each collaborator 810 may be obtained from the hardware information of the hand-held electronic device of each collaborator 810 by way of connecting to the social network service. The geographic position of each collaborator 810 may be obtained through a positioning module. Whether the network status of each collaborator 810 is smooth may be tested through the instant transmission of packets.

In the present embodiment, the searching unit 120 may periodically searches the collaborators 810 in the social network service 900 and record relevant information of the collaborators 810. In an embodiment, the searching unit 120 may perform the searching procedure when the distributing collaborative computer editing procedure is activated.

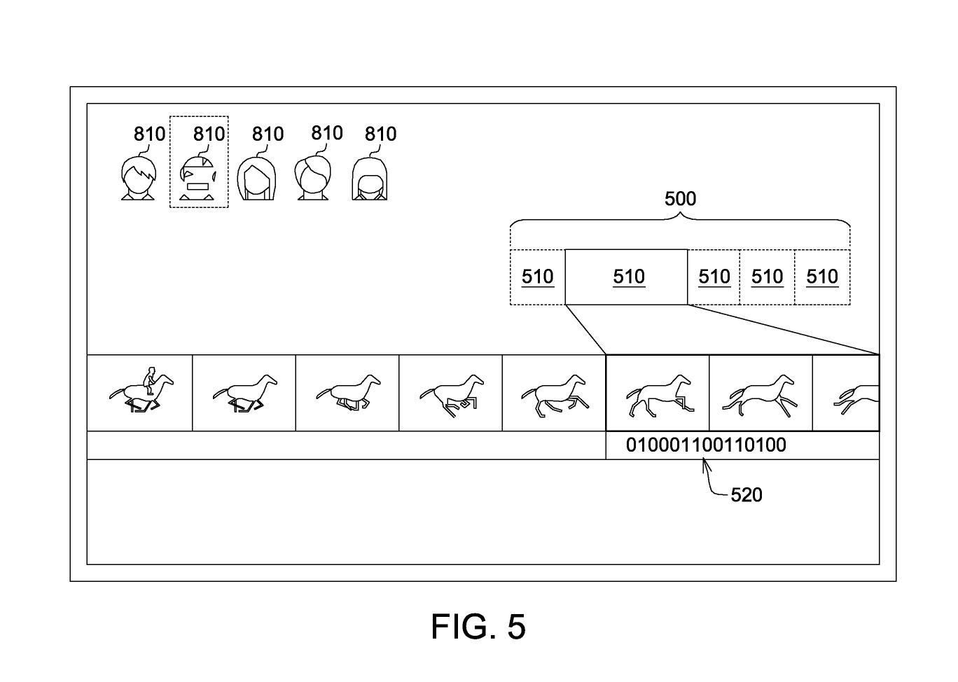

Referring to FIG. 1 and FIGS. 4 to 5, FIGS. 4 to 5 show a schematic diagram of a multimedia 500. The splitting unit 130 is used for splitting the multimedia 500 into a plurality of parts 510. The file size or time of each part 510 may be the same or different. In an embodiment, the splitting unit 130 may perform the splitting procedure according to the background, scene transitions, facial expression or human voice contained in the multimedia 500. For example, the time when the background is changed to the outdoor form the office may be used as a splitting point. Or, the time when a human's voice turns to deep voice from high pitch may also be used as a splitting point. Meanwhile, the splitting unit 130 adds a metadata 520 to each part 510. Each metadata 520 records the starting time and splitting factors of each part 510, and the host 710 which provides the multimedia 500. The splitting factors are such as the background being the office or the outdoor and the voice being high-pitched or deep as described above.

The distributing unit 140 then distributes the parts 510 to the collaborators 810 according to the interests, photos, processing efficiency and position of the collaborators 810. In an example illustrated in FIG. 4, the searching unit 120 searches and finds out that the third collaborator 810 raises two kids, and the first part 510 shows one kid. Therefore, the distributing unit 140 judges that the third collaborator 810 may be interested in the first part 510, and accordingly distributes the first part 510 to the third collaborator 810. In another example illustrated in FIG. 5, another part 510 is distributed to the collaborator 810. As indicated in FIG. 5, the searching unit 120 searches and finds out that the second collaborator 810 publishes an article about his/her observation of the horse in the social network service 900, while the second part 510 shows horse galloping. Therefore, the distributing unit 140 judges that the second collaborator 810 may be interested in the second part 510, and accordingly distributes the second part 510 to the second collaborator 810. In another example, if the searching unit 120 finds out that the processing efficiency of the first collaborator 810 is much better than that of other collaborators, then the distributing unit 140 distributes the parts 510 having larger size or longer time, even more than one parts 510 to the first collaborator 810. In another example, if the searching unit 120 finds out that the network status of the first collaborator 810 is much better than that of other collaborators (for example, the first collaborator 810 has 4G network while other collaborators 810 only have 3G network; or, the network status of the first collaborator 810 is smooth while the network status of other collaborators 810 is not smooth), then the distributing unit 140 accordingly distributes the parts 510 having larger size or longer time, even more than parts 510 to the first collaborator 810. In another example, if the searching unit 120 finds out that the first collaborator 810 is currently positioned at an office while other collaborators 810 are positioned at home, then the distributing unit 140 judges that the first collaborator 810 is busy and it is not suitable to distribute the part 510 to the first collaborator 810.

During the distribution process, the distributing unit 140 inquires the collaborators 810 whether they are willing to participate the collaborative editing. If the distributed collaborator 810 shows no willingness to participate the editing, then the distributing unit 140 will re-distribute the part 510, that has been distributed to the unwilling collaborator 810, to the other collaborator 810.

During the distribution process, each metadata 520 further records each part 510 distributed to which collaborator 810 for the convenience of subsequent tracking.

After all parts 510 are distributed to the collaborators 810 and the collaborators 810 are inquired of their willingness, the distributing unit 140 distributes the parts 510 to respective distributed collaborators 810. The collaborators 810 are thus able to edit or enjoy the part 510 distributed thereto. In a practical embodiment, a plurality of parts 510 may be distributed to one single collaborator 810.

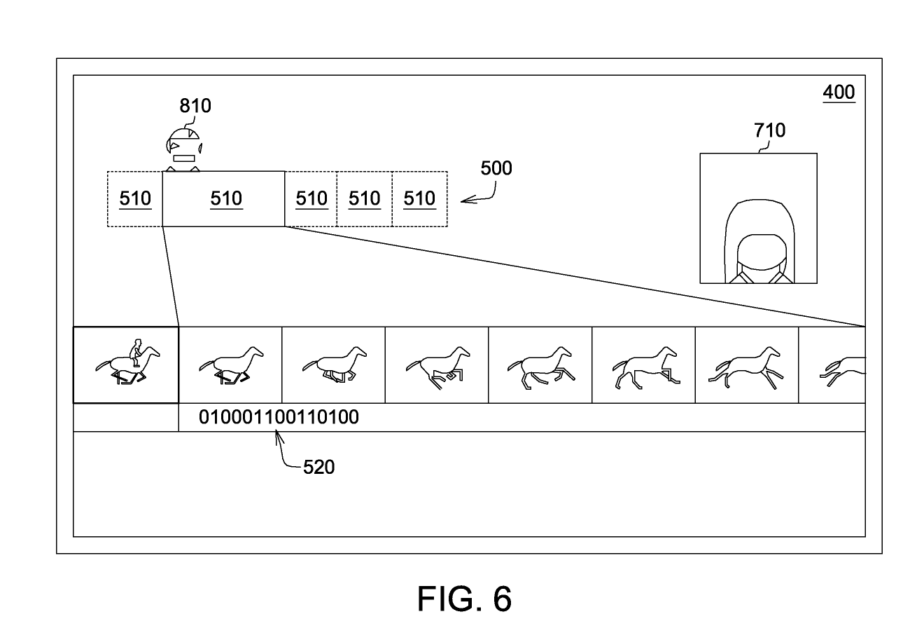

Referring to FIG. 6, a schematic diagram of an instant communication interface 400 is shown. In the present embodiment, when each collaborator 810 edits a part 510, instant communication interface 400 provides instant communication with each collaborator 810 to the host 710. Thus, the host 710 may directly and instantly communicate with the collaborator 810 regarding the content of editing. The instant communication interface 400 may instantly transmit the text message or share the operation of the editing process. Or, the instant communication interface 400 may show partial part 510 or directly display the edited part 510.

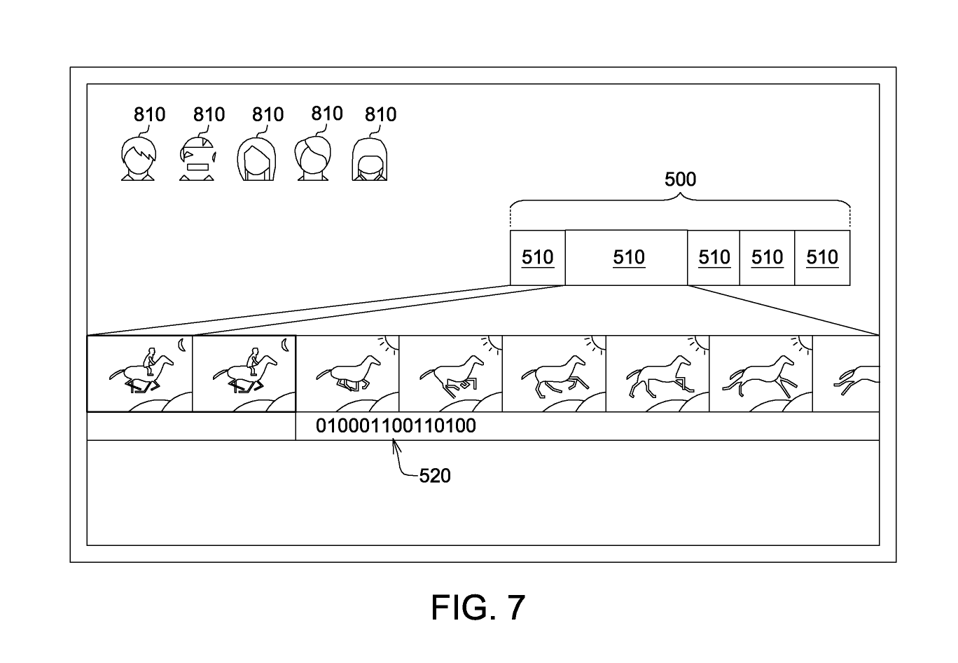

After the collaborator 810 finishes editing the part 510 distributed thereto, the collaborator 810 may upload the edited part 510 to the storage unit 110 or the host 710. The aggregating unit 150 then aggregates the edited parts 510. Since the metadata 520 of each part 510 records the starting time and the host 710, the cloud server 620 or the host 710 may aggregate the edited parts 510 according to the sequence of the start time. Referring to FIG. 7, a schematic diagram of an edited and aggregated multimedia 500. As indicated in FIG. 7, all the edited parts 510 are aggregated, and become a brilliant multimedia 500. Such multimedia 500 is produced by the collaborators 810 working together as a team, so that the collaborators 810 have a sense of participation in the editing of the multimedia 500.

As indicated in FIGS. 1 to 2, the aggregating unit 150 may aggregate the edited parts 510 in the cloud server 610, 620 or in the host 730 as indicated in FIG. 3. Alternatively, when the point to point (P to P) network is used and each collaborator 810 is equipped with the availability of the aggregating unit 150, then the aggregating procedure may aggregate the edited parts 510 in any collaborator 810.

The above embodiments provide a way of editing the multimedia 500 in a distributing and collaborative manner through the resources of the social network service 900. This distributing and collaborative way of editing not only increases the editing efficiency of the multimedia 500 but also adds more funs to editing and increases the interaction between people, and signifies a significant change in the way of editing the multimedia 500.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A distributing collaborative computer editing system, comprising:
a storage unit used for storing a multimedia provided from a host;
a searching unit used for searching a plurality of collaborators via a social network service associated with the host;
a splitting unit used for splitting the multimedia into a plurality of parts;
a distributing unit used for distributing the parts to the collaborators, such that the collaborators can edit the parts respectively; and
an aggregating unit used for aggregating the edited parts.

2. The distributing collaborative computer editing system according to claim 1, wherein the searching unit periodically searches the collaborators in the social network service and records the collaborators.

3. The distributing collaborative computer editing system according to claim 1, wherein the splitting unit performs splitting according to the background, scene transitions, facial expression or human voice of the multimedia.

4. The distributing collaborative computer editing system according to claim 3, wherein the splitting unit further adds a metadata to each part, and each metadata records a starting time.

5. The distributing collaborative computer editing system according to claim 1, wherein the distributing unit performs distribution according to interest, photos, processing performance, network status or position of the collaborators.

6. The distributing collaborative computer editing system according to claim 5, wherein the splitting unit further adds a metadata to each part, and each metadata records each part distributed to which collaborator.

7. The distributing collaborative computer editing system according to claim 1, wherein the splitting unit further adds a metadata to each part, and each metadata records the host.

8. The distributing collaborative computer editing system according to claim 1, wherein the multimedia is a video file or an audio file.

9. The distributing collaborative computer editing system according to claim 1, wherein the aggregating unit aggregates the edited parts in a server.

10. The distributing collaborative computer editing system according to claim 1, wherein the aggregating unit aggregates the edited parts in the host or one of the collaborators.
